(19) United States
(12) Patent Application Publication
(10) Pub. No.: US 2024/0392043 A1
(43) Pub. Date: Nov. 28, 2024

(54) PROCESS FOR PRODUCING A PROPYLENE COPOLYMER

(71) Applicant: BOREALIS AG, Vienna (AT)

(72) Inventors: Pauli Leskinen, Porvoo (FI); Jingbo Wang, Linz (AT); Markus Gahleitner, Linz (AT); Klaus Bernreitner, Linz (AT); Antonina Kupareva, Porvoo (FI)

(73) Assignee: BOREALIS AG, Vienna (AT)

(21) Appl. No.: 18/694,621

(22) PCT Filed: Sep. 15, 2022
(86) PCT No.: PCT/EP2022/075697

§ 371 Date: Mar. 22, 2024

(30) Foreign Application Priority Data
Sep. 23, 2021 (EP) 21198601.3

(51) Int. Cl. C08F 2/01; C08F 2/14; C08F 2/34; C08F 4/659; C08F 4/6592; C08F 255/02

(52) U.S. Cl. CPC C08F 2/01; C08F 2/14; C08F 2/34; C08F 4/65908; C08F 4/65912; C08F 4/65916; C08F 4/65927; C08F 255/023; C08F 2400/02; C08F 2420/02

(57) ABSTRACT

Process for the production of a polypropylene random copolymer (PP), the process comprising the steps of polymerising in a first reactor (R1) propylene and a comonomer (C1a) selected from a C₄ to C₈ α-olefin in the presence of a first metallocene catalyst (MC1) yielding a first polypropylene copolymer (PP1), wherein the ratio of the feed of the comonomer (C1a) to the feed of propylene is in the range of 1 to 100 mol/kmol and the MFR₂ of the first polypropylene copolymer (PP1) is in the range of 0.01 to 100 g/10 min; transferring the first polypropylene copolymer (PP1) to a second reactor (R2); polymerising in the second reactor (R2) and in the presence of said first polypropylene (PP1), propylene, a comonomer (C1b) selected from a C₄ to C₈ α-olefin, and a second metallocene catalyst (MC2) yielding a second polypropylene copolymer (PP2), wherein the ratio of the feed of the comonomer (C1b) to the feed of propylene is in the range of 40 to 150 mol/kmol and the MFR₂ of the second polypropylene copolymer (PP2) is in the range of 0.01 to 100 g/10 min; withdrawing the polypropylene random copolymer (PP) comprising the first polypropylene copolymer (PP1) and the second polypropylene copolymer (PP2) from the second reactor (R2); wherein the first metallocene catalyst (MC1) and/or the second metallocene catalyst (MC2) is a metallocene catalyst (MC) comprising a metallocene complex, and wherein the metallocene catalyst (MC) comprises a support comprising silica.

The present invention is concerned with a process for producing a propylene copolymer with a comonomer selected from C₄ to C₈ α-olefins in the presence of a metallocene catalyst. In particular, the present invention relates to such a process with an improved comonomer conversion in the process and low residual comonomer content in the final product.

### BACKGROUND

Polypropylene based copolymers like propylene-ethylene copolymers are widely used in moulding applications, such as thin wall packaging applications, which require a combination of good mechanical properties—e.g. high stiffness and impact strength—and optical properties.

Therefore, there is a general interest to improve the efficiency of polymerisation processes of such polypropylene copolymers. In polypropylene polymerisation processes known in the prior art, the comonomer reactivity and conversion generally is poor.

Consequently, the products produced of such processes generally have high hydrocarbon residuals. Such residuals are problematic in food and medical packaging areas, as the residuals can travel from the packaging material into the packaged material.

A further consequence is that the operability of the polymerisation process is not reliable on the target area, as the optimal product area is on the border of the operation window.

As higher amounts of comonomer are needed to achieve certain comonomer contents in the polymer chains, also additional equipment such as comonomer recovery sections have to be provided downstream of the polymerisation reactor.

A further drawback of the higher amounts of comonomer is that also the losses of comonomer over the whole polymerisation process are higher.

All these challenges can lead to situations where the production rate has to be limited to about 50% of the normal capacity of the plant. Thus, generally, the propylene copolymer polymerisation processes known in the prior art are less efficient, thereby producing high production costs as well as products with less optimal property profiles.

WO 2020/099566 A1 tries to solve those problems by a process for obtaining a multimodal propylene butene random copolymer having a melt flow rate (MFR₂) of 1.0 to 20.0 g/10 min and a butene content of 1.5 to 8.0 wt %, wherein said copolymer is prepared using a single site catalyst and wherein said copolymer comprises: (i) 30 to 70 wt % of a propylene butene copolymer (A) having an MFR₂ of 0.5 to 20.0 g/10 min and a butene content of 0.5 to 10.0 wt %; and (ii) 70 to 30 wt % of a propylene butene copolymer (B) having an MFR₂ of 0.5 to 20.0 g/10 min and a butene content of 1.0 to 8.0 wt %; wherein copolymers (A) and (B) are different.

WO 2020/099563 A1 tries to solve those problems by a process for obtaining a multimodal propylene butene random copolymer having a melt flow rate (MFR₂) of 1.0 to 20.0 g/10 min and a butene content of 5.0 to 20.0 wt %, wherein said copolymer is prepared using a single site catalyst and wherein said copolymer comprises: (i) 30 to 70 wt % of a propylene butene copolymer (A) having an MFR₂ of 0.5 to 20.0 g/10 min and a butene content of 2.0 to 10.0 wt %; and (ii) 70 to 30 wt % of a propylene butene copolymer (B) having an MFR₂ of 0.5 to 20.0 g/10 min and a butene content of 4.0 to 20.0 wt %; wherein copolymers (A) and (B) are different.

However, while these processes of the prior art are able to achieve high comonomer conversions rates, they have the drawback that the comonomer content in the final product is still not as low as some food or medical applications require.

Therefore, there is the constant need for further improving the polymerisation processes of multimodal propylene random copolymers in view reduced amounts of volatiles in the final product.

### Object of the Present Invention

It is therefore an object of the present invention to provide a process for the polymerisation of a propylene random copolymer fulfilling the requirements as described beforehand, e.g. achieving a well-balanced combination of mechanical and optical properties of the product as well as high comonomer conversion rates, which yields products with improved, i.e. reduced, amounts of volatiles in the final product.

### Definitions

The term ‘copolymer of [monomer]’ as used herein denotes a polymer the majority by weight of which derives from the [monomer] units (i.e. at least 50 wt. % [monomer] relative to the total weight of the copolymer).

### SUMMARY OF THE INVENTION

It now has been surprisingly found that above-mentioned object can be achieved by a process for the production of a polypropylene random copolymer (PP), the process comprising the steps of
a) polymerising in a first reactor (R1) propylene and a comonomer (C1a) selected from a C₄ to C₈ α-olefin in the presence of a first metallocene catalyst (MC1) yielding a first polypropylene copolymer (PP1), wherein the ratio of the feed of the comonomer (C1a) to the feed of propylene is in the range of 1 to 100 mol/kmol and the MFR₂ of the first polypropylene copolymer (PP1) is in the range of 0.01 to 100 g/10 min.
b) transferring the first polypropylene copolymer (PP1) to a second reactor (R2),
c) polymerising in the second reactor (R2) and in the presence of said first polypropylene (PP1), propylene, a comonomer (C1b) selected from a C₄ to C₈ α-olefin, and a second metallocene catalyst (MC2) yielding a second polypropylene copolymer (PP2), wherein the ratio of the feed of the comonomer (C₁b) to the feed of propylene is in the range of 40 to 150 mol/kmol and the MFR₂ of the second polypropylene copolymer (PP2) is in the range of 0.01 to 100 g/10 min,
d) withdrawing the polypropylene random copolymer (PP) comprising the first polypropylene copolymer (PP1) and the second polypropylene copolymer (PP2) from the second reactor (R2),
   wherein the first metallocene catalyst (MC1) and/or the second metallocene catalyst (MC2) is a metallocene catalyst (MC) comprising a metallocene complex, and
      wherein the metallocene catalyst (MC) comprises a support comprising silica.

Preferably, in the process according to the present invention, the comonomer (C1a) and/or the comonomer (C1b) are/is selected from the group consisting of C₄ and C₆ α-olefins, preferably are/is 1-butene.

Furthermore, in the process according to the present invention, the comonomer (C1a) and the comonomer (C1b) are identical.

In an especially preferred embodiment of the present invention, in the process of the invention the polypropylene random copolymer (PP) is a terpolymer. In such a process step a) is carried out in the presence of a second comonomer (C2) selected from the group consisting of ethylene and C₄ to C₈ α-olefins, wherein the second comonomer (C2) is different from the comonomer (C1a/C1b), wherein the ratio of the feed of the second comonomer (C2) to the feed of propylene is in the range of 5 to 60 mol/kmol, and step c) is carried out in the presence of the second comonomer (C2), wherein the ratio of the feed of the second comonomer (C2) to the feed of propylene is in the range of 50 to 150 mol/kmol. Preferably, in this especially preferred embodiment, the second comonomer (C2) is ethylene.

The temperature as used in step a) is typically from 60 to 100° C., preferably from 60 to 90° C. Preferably, step a) is carried out at a temperature from 60 to 80° C., more preferably 65 to 75° C., and most preferably 68 to 70° C. An excessively high temperature should be avoided to prevent partial dissolution of the polymer into the diluent and the fouling of the reactor. The pressure as used in step a) is preferably from 1 to 150 bar, more preferably 35 to 60 bar, even more preferably 40 to 55 bar, and most preferably 43 to 52 bar.

In step a) the ratio of the feed of the comonomer (C1a) to the feed of propylene is preferably in the range from 30 to 70 mol/kmol, more preferably in the range from 35 to 65 mol/kmol. In a preferred embodiment of the invention, in step a) the ratio of the feed of the second comonomer (C2) to the feed of propylene is in the range from 10 to 20 mol/kmol, preferably from 13 to 18.5 mol/kmol.

The first polypropylene copolymer (PP1) produced in step a) has preferably a MFR₂ in the range from 0.1 to 10 g/10 min, more preferably from 2 to 8 g/10 min, most preferably 3 to 5 g/10 min. Moreover, the first polypropylene copolymer (PP1) preferably has a xylene soluble content (XCS) of lower than 1.5 wt %, more preferably lower than 1.2 wt %, and most preferably lower than 1.0 wt %. Typically, the xylene soluble content (XCS) of the first polypropylene copolymer (PP1) is higher than 0.1 wt %.

Step a) is preferably a slurry polymerisation step. The slurry polymerisation usually takes place in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons. An especially preferred diluent is propane, possibly containing minor amount of methane, ethane and/or butane. The slurry polymerisation may be conducted in any known reactor used for slurry polymerisation. Such reactors include a continuous stirred tank reactor and a loop reactor. It is especially preferred to conduct the polymerisation in a loop reactor. In such reactors, the slurry is circulated with a high velocity along a closed pipe by using a circulation pump.

Loop reactors are generally known in the art and examples are given, for instance, in U.S. Pat. Nos. 4,582,816, 3,405,109, 3,324,093, EP-A-479186 and U.S. Pat. No. 5,391,654. It is thus preferred to conduct the first polymerisation stage as a slurry polymerisation in a loop reactor.

The slurry may be withdrawn from the reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295 and EP-A-1591460. It is preferred to withdraw the slurry from the first polymerisation stage continuously.

Hydrogen is typically introduced into the first polymerisation stage for controlling the MFR₂ of the first propylene copolymer (PP1). The amount of hydrogen needed to reach the desired MFR₂ depends on the catalyst used and the polymerisation conditions, as will be appreciated by the skilled worker.

The average residence time in the first polymerisation stage is typically from 20 to 120 min, preferably from 30 to 80 min. As it is well known in the art the average residence time T can be calculated from equation (1) below:

$$τ = \frac{{V}_{R}}{{Q}_{o}} \qquad equation ( 1 )$$

wherein
V_{R} is the volume of the reaction space (in case of a loop reactor, the volume of the reactor, in case of the fluidized bed reactor, the volume of the fluidized bed)
Qₒ is the volumetric flow rate of the product stream (including the polymer product and the fluid reaction mixture).

The production rate is suitably controlled with the catalyst feed rate. It is also possible to influence the production rate by suitable selection of the monomer concentration. The desired monomer concentration can then be achieved by suitably adjusting the propylene feed rate.

Step c) is preferably a gas phase polymerisation step, i.e. carried out in a gas-phase reactor. Any suitable gas phase reactor known in the art may be used, such as a fluidized bed gas phase reactor.

For gas phase reactors, the reaction temperature used will generally be in the range 30 to 90° C., the reactor pressure will generally be in the range 10 to 40 bar, and the residence time will generally be 1 to 8 hours. The gas used will commonly be a non-reactive gas such as nitrogen or low boiling point hydrocarbons such as propane together with monomer (e.g. ethylene). Preferably, the temperature in step c) is in the range of 60 to 88° C., more preferably 75 to 85° C. Respectively, step c) is preferably carried out at a pressure in the range of 15 to 26 bar, more preferably 20 to 25 bar.

In step c) the ratio of the feed of the comonomer (C1b) to the feed of propylene is preferably in the range of 40 to 60 mol/kmol, more preferably 45 to 51 mol/kmol. Moreover, the ratio of the feed of the second comonomer (C2) to the feed of propylene is preferably in the range of 70 to 130 mol/kmol, more preferably 75 to 115 mol/kmol.

Furthermore, the MFR₂ of the second polypropylene copolymer (PP2) produced in step c) is in preferably the range of 0.01 to 10 g/10 min, more preferably 2 to 8 g/10 min, and most preferably 4 to 7 g/10 min.

A chain transfer agent (e.g. hydrogen) is typically added to step c).

Preferably, the total conversion of the comonomer (C1a, C1b) in steps a) and c) is higher than 12%, preferably higher than 15%, more preferably higher than 19% even more preferably higher than 22%, in particular more preferably higher than 28%, and most preferably higher than 40%.

In a preferred embodiment of the invention, the first metallocene catalyst (MC1) and the second metallocene catalyst (MC2) are identical.

Preferably, the polypropylene random copolymer (PP) has a combined residual content of the comonomer (C1a) and the comonomer (C1b) of lower than or equal to 6.5 wt %, preferably lower than or equal to 5 wt %, and most preferably lower than or equal to 4 wt %. The (combined) residual comonomer content may be detected via static headspace gas chromatography.

In a further preferred embodiment of the invention, the polymerisation process does not comprise a step of recovering the comonomer (C1a) or the comonomer (C1b).

The production split between the first polypropylene copolymer (PP1) of step a) and the second polypropylene copolymer (PP2) of step c) is preferably in the range of from 30:70 to 70:30, more preferably 35:65 and 65:35, and most preferably 40:50 and 60:50.

A preferred process is the above-identified slurry-gas phase process, such as developed by Borealis and known as the Borstar® technology. In this respect, reference is made to the EP applications EP 0 887 379 A1 and EP 0 517 868 A1.

The polymerisation steps discussed above may be preceded by a prepolymerisation step. Hence, the process according to the present invention preferably further comprises the following step preceding step a):
a′) prepolymerising propylene in the presence of the first metallocene catalyst (MC1).

The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is typically conducted in slurry.

Thus, the prepolymerisation step may be conducted in a loop reactor. The prepolymerisation is then preferably conducted in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons.

The temperature in the prepolymerisation step is typically from 0 to 90° C., preferably from 20 to 80° C. The pressure is not critical and is typically from 1 to 150 bar, preferably from 40 to 80 bar.

The amount of monomer is typically such that from 0.1 to 1000 g of monomer per one gram of solid catalyst component is polymerised in the prepolymerisation step. As the person skilled in the art knows, the catalyst particles recovered from a continuous prepolymerisation reactor do not all contain the same amount of prepolymer. Instead, each particle has its own characteristic amount, which depends on the residence time of that particle in the prepolymerisation reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additives may be used to prevent the particles from adhering to each other or the walls of the reactor, as disclosed in WO-A-96/19503 and WO-A-96/32420.

The catalyst components are preferably all introduced to the prepolymerisation step when a prepolymerisation step is present. However, where the solid catalyst component and the cocatalyst can be fed separately it is possible that only a part of the cocatalyst is introduced into the prepolymerisation stage and the remaining part into subsequent polymerisation stages. Also in such cases, it is necessary to introduce so much cocatalyst into the prepolymerisation stage that a sufficient polymerisation reaction is obtained therein.

It is understood within the scope of the invention, that the amount of polymer produced in the prepolymerisation typically lies within 1.0-5.0 wt.-% in respect to the propylene random copolymer (PP).

The propylene random copolymer (PP) is prepared in the presence of at least one metallocene catalyst. A metallocene catalyst typically comprises a metallocene/activator reaction product impregnated in a porous support at maximum internal pore volume. The catalyst complex comprises a ligand which is typically bridged, and a transition metal of group IVa to VIa, and an organoaluminium compound. The catalytic metal compound is typically a metal halide.

The metallocene catalyst according to the present invention may be any supported metallocene catalyst suitable for the production of isotactic polypropylene.

It is preferred that the single site catalyst (SSC) comprises a metallocene complex, a co-catalyst system comprising a boron-containing co-catalyst and/or aluminoxane co-catalyst, and a silica support.

Preferably, the first and/or the second metallocene catalyst is/are a catalyst comprising a complex of formula (I):

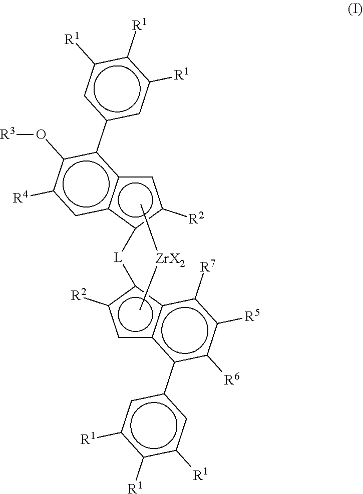

wherein each X independently is a sigma-donor ligand,
L is a divalent bridge selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table,
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′₃, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like C₁, or methyl or benzyl.

A preferred monovalent anionic ligand is halogen, in particular chlorine (Cl).

More information, in particular about the preparation of such catalyst, can be found e.g. in WO 2013/007650 A1.

Preferred complexes of the metallocene catalyst include:
rac-dimethylsilanediylbis[2-methyl-4-(3′,5′-dimethylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl] zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl] [2-methyl-4-(3′,5′-dimethylphenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

Especially preferred is rac-anti-dimethylsilanediyl[2-methyl-4,8-bis-(3′,5′-dimethylphenyl)-1,5,6,7-tetrahydro-s indacen-1-yl] [2-methyl-4-(3′,5′-dimethylphenyl)-5-methoxy-6-tert-butylinden-1-yl] zirconium dichloride.

Also especially preferred, the first and/or the second metallocene catalyst is/are a catalyst comprising a complex of formula (II):

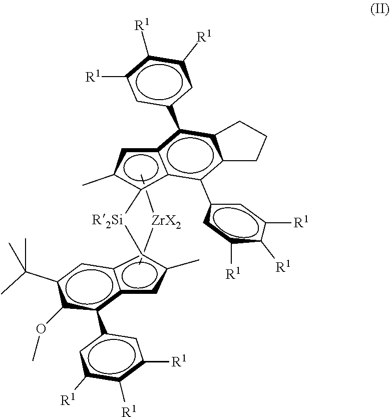

wherein each R¹ are independently the same or can be different and are hydrogen or a linear or branched C₁-C₆ alkyl group, whereby at least on R¹ per phenyl group is not hydrogen,
R′ is a C₁-C₁₀ hydrocarbyl group, preferably a C₁-C₄ hydrocarbyl group and more preferably a methyl group and X independently is a hydrogen atom, a halogen atom, C₁-C₆ alkoxy group, C₁-C₆ alkyl group, phenyl or benzyl group.

Most preferably, X is chlorine, benzyl or a methyl group. Preferably, both X groups are the same. The most preferred options are two chlorides, two methyl or two benzyl groups, especially two chlorides.

Specific preferred metallocene catalysts of the invention include:
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride
rac-anti-dimethylsilanediyl[2-methyl-4,8-bis-(3′,5′-dimethylphenyl)-1,5,6,7-tetrahydro-s-5 indacen-1-yl] [2-methyl-4-(3′,5′-dimethylphenyl)-5-methoxy-6-tert-butylinden-1-yl] zirconium dichloride
rac-anti-dimethylsilanediyl[2-methyl-4,8-bis-(3′,5′-dimethylphenyl)-1,5,6,7-tetrahydro-sindacen-1-yl] [2-methyl-4-(3′,5′-ditert-butyl-phenyl)-5-methoxy-6-tert-butylinden-1-yl] zirconium dichloride or their corresponding zirconium dimethyl analogues.

Especially preferred is rac-anti-dimethylsilanediyl[2-methyl-4,8-bis-(3′,5′-dimethylphenyl)-1,5,6,7-tetrahydros-indacen-1-yl] [2-methyl-4-(3′,5′-dimethylphenyl)-5-methoxy-6-tert-butylinden-1-yl] zirconium dichloride according to formula (III):

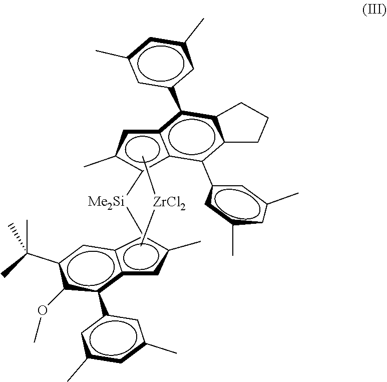

The ligands required to form the complexes and hence catalysts of the invention can be synthesized by any process and the skilled organic chemist would be able to devise various synthetic protocols for the manufacture of the necessary ligand materials. For example WO 2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959 in which the most preferred catalyst of the present invention is described.

To form an active catalytic species it is normally necessary to employ a cocatalyst as is well known in the art.

According to the present invention a cocatalyst system comprising a boron containing cocatalyst and/or an aluminoxane cocatalyst is used in combination with the above defined metallocene catalyst complex.

The aluminoxane cocatalyst can be one of formula (IV):

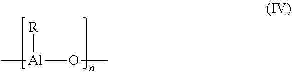

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (III).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

According to the present invention, also a boron containing cocatalyst can be used instead of the aluminoxane cocatalyst or the aluminoxane cocatalyst can be used in combination with a boron containing cocatalyst.

It will be appreciated by the person skilled in the art that where boron based cocatalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used, the metallocene catalyst complex is in its alkylated version, that is for example a dimethyl or dibenzyl metallocene catalyst complex can be used.

Boron based cocatalysts of interest include those of formula (V)

BY₃ (V)

wherein Y is the same or different and is a hydrogen atom, an alkyl group of from 1 to about 8 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris(3,4,5-trifluorophenyl)borane.

Particular preference is given to tris(pentafluorophenyl)borane.

However it is preferred that borates are used, i.e. compounds containing a borate 3+ ion.

Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
triethylammoniumtetra(phenyl)borate,
tributylammoniumtetra(phenyl)borate,
trimethylammoniumtetra(tolyl)borate,
tributylammoniumtetra(tolyl)borate,
tributylammoniumtetra(pentafluorophenyl)borate,
tripropylammoniumtetra(dimethylphenyl)borate,
tributylammoniumtetra(trifluoromethylphenyl)borate,
tributylammoniumtetra(4-fluorophenyl)borate,
N,N-dimethylcyclohexylammoniumtetrakis(pentafluorophenyl)borate,
N,N-dimethylbenzylammoniumtetrakis(pentafluorophenyl)borate,
N,N-dimethylaniliniumtetra(phenyl)borate,
N,N-diethylaniliniumtetra(phenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakist(pentafluorophenyl)borate,
triphenyIphosphoniumtetrakis(phenyl)borate,
triethylphosphoniumtetrakis(phenyl)borate,
diphenylphosphoniumtetrakis(phenyl)borate,
tri(methylphenyl)phosphoniumtetrakis(phenyl)borate,
tri(dimethylphenyl)phosphoniumtetrakis(phenyl)borate,
triphenylcarbeniumtetrakis(pentafluorophenyl)borate,
or ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate.

It has been surprisingly found that certain boron cocatalysts are especially preferred.

Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

According to the present invention, the preferred cocatalysts are aluminoxanes, more preferably methylaluminoxanes, combinations of aluminoxanes with Al-alkyls, boron or borate cocatalysts, and combination of aluminoxanes with boron-based cocatalysts.

Suitable amounts of cocatalyst will be well known to the person skilled in the art.

The molar ratio of boron to the metal ion of the metallocene may be in the range 0.5:1 to 35 10:1 mol/mol, preferably 1:1 to 10:1 mol/mol, especially 1:1 to 5:1 mol/mol.

The molar ratio of Al in the aluminoxane to the metal ion of the metallocene may be in the range 1:1 to 2000:1 mol/mol, preferably 10:1 to 1000:1 mol/mol, and more preferably 50:1 to 500:1 mol/mol.

The catalyst used in the polymerisation process of the present invention is used in supported form. The particulate support material used comprises, preferably consists of, silica. The person skilled in the art is aware of the procedures required to support a metallocene catalyst.

Especially preferably, the support is a porous material so that the complex may be loaded into the pores of the support, e.g. using a process analogous to those described in WO 94/14856 (Mobil), WO 95/12622 (Borealis) and WO 2006/097497.

The average particle size of the silica support can be typically from 10 to 100 μm. However, it has turned out that special advantages can be obtained if the support has an average particle size from 15 to 80 μm, preferably from 18 to 50 μm.

The particle size distribution of the silica support is described in the following. The silica support preferably has a D50 of between 10 and 80 μm, preferably 18 and 50 μm. Furthermore, the silica support preferably has a D10 of between 5 and 30 μm and a D90 of between 30 and 90 μm. Preferably, the silica support has a SPAN value of 0.1 to 0.7, preferably 0.2 to 0.6.

The average pore size of the silica support can be in the range 10 to 100 nm, preferably 20 to 50 nm and the pore volume from 1 to 3 ml/g, preferably 2 to 2.5 ml/g. The average pore size may be determined via conventional methods, such as the BET (Brunauer-Emmett-Teller) method using nitrogen gas.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

All or part of the preparation steps can be done in a continuous manner. Reference is made to WO 2006/069733 describing principles of such a continuous or semicontinuous preparation methods of the solid catalyst types, prepared via emulsion/solidification method. The formed catalyst preferably has good stability/kinetics in terms of longevity of reaction, high activity and the catalysts enable low ash contents.

The use of the heterogeneous, non-supported catalysts, (i.e. ‘self-supported’ catalysts) might have, as a drawback, a tendency to dissolve to some extent in the polymerisation media, i.e. some active catalyst components might leach out of the catalyst particles during slurry polymerisation, whereby the original good morphology of the catalyst might be lost. These leached catalyst components are very active possibly causing problems during polymerisation. Therefore, the amount of leached components should be minimized, i.e. all catalyst components should be kept in heterogeneous form.

Furthermore, the self-supported catalysts generate, due to the high amount of catalytically active species in the catalyst system, high temperatures at the beginning of the polymerisation which may cause melting of the product material. Both effects, i.e. the partial dissolving of the catalyst system and the heat generation, might cause fouling, sheeting and deterioration of the polymer material morphology.

In order to minimize the possible problems associated with high activity or leaching, it is preferred to ‘prepolymerise’ the catalyst before using it in polymerisation process. It has to be noted that prepolymerisation in this regard is part of the catalyst preparation process, being a step carried out after a solid catalyst is formed. This catalyst prepolymerisation step is not part of the actual polymerisation configuration, which might comprise a conventional process prepolymerisation step as well. After the catalyst prepolymerisation step, a solid catalyst is obtained and used in polymerisation.

Catalyst ‘prepolymerisation’ takes place following the solidification step of the liquid-liquid emulsion process hereinbefore described. Prepolymerisation may take place by known methods described in the art, such as that described in WO 2010/052263, WO 2010/052260 or WO 2010/052264. Use of the catalyst prepolymerisation step offers the advantage of minimizing leaching of catalyst components and thus local overheating.

The solvent employed in the processes of the invention may be any solvent suitable for use in olefin polymerisation and is typically a mixture of hydrocarbons. Such solvents are well known in the art. Examples of solvents include hexane, cyclohexane, isohexane, n-heptane, C₈, C₉ isoparaffins and mixtures thereof.

In one embodiment, the polymerisation is carried out in the presence of hydrogen. Hydrogen is typically employed to help control polymer properties, such as polymer molecular weight. In an alternative embodiment, hydrogen is not added in step a) or c). The skilled worker will appreciate, however, that hydrogen may be generated during the polymerisation process. Thus, the hydrogen present in the polymerisation reaction mixture formed in step a) or c) of the process may originate from hydrogen which has been added as a reactant and/or hydrogen produced as a side product during polymerisation.

It will be appreciated that the propylene polymers may contain standard polymer additives. These typically form less than 5.0 wt.-%, such as less than 2.0 wt.-% of the polymer material. Additives, such as antioxidants, phosphites, cling additives, pigments, colorants, fillers, anti-static agent, processing aids, clarifiers and the like may thus be added during the polymerisation process. These additives are well known in the industry and their use will be familiar to the artisan. Any additives which are present may be added as an isolated raw material or in a mixture with a carrier polymer, i.e. in so called master batch.

In one embodiment of the invention, the process for preparing the multimodal propylene butene copolymer may further comprise a step of visbreaking. The term ‘visbreaking’ will be well known to the person skilled in the art and relates to a process which results in a controlled breakdown of polymer chains, leading to rheological changes, typically an increase in MFR₂. Thus, the multimodal polymers of the invention may be subject to visbreaking to finely tune their rheological profile, as desired. Visbreaking may take place by several methods, as are well known in the art, such as thermal pyrolysis, exposure to ionising radiation or oxidising agents. In the context of the present invention, visbreaking is typically carried out using peroxides.

### Experimental Part

### Measurement Methods

Any parameter mentioned above in the detailed description of the invention is measured according to the tests given below.

### a) Melt Flow Rate

The melt flow rate (MFR) is determined according to ISO 1133 and is indicated in g/10 min. The MFR is an indication of the melt viscosity of the polymer. The MFR is determined at 190° C. for PE and 230° C. for PP. The load under which the melt flow rate is determined is usually indicated as a subscript, for instance MFR₂ is measured under 2.16 kg load (condition D).

The MFR₂ of the second propylene copolymer (PP2), produced in the second reactor is determined according to equation (2):

$$log ( MFR ( PP 2 ) ) = \frac{log ( MFR ( PP ) ) - w ( PP 1 ) * log ( MFR ( PP 1 ) )}{w ( PP 2 )} \qquad equation ( 2 )$$

wherein
MFR(PP) is the MFR₂ of the propylene random copolymer (PP)
w(PP1) and w(PP2) are the weight fractions of the first propylene copolymer (PP1) and the second propylene copolymer (PP2) in the propylene random copolymer (PP)
MFR(PP1) is the MFR₂ of the first propylene copolymer (PP1) produced in the first reactor.

### b) Particle Size and Particle Size Distribution

The particle size distribution was determined using laser diffraction measurements by Coulter LS 200. The particle size and particle size distribution is a measure for the size of the particles. The D-values (D10 (or d10), D50 (or d50) and D90 (or d90)) represent the intercepts for 10%, 50% and 90% of the cumulative mass of sample. The D-values can be thought of as the diameter of the sphere which divides the sample's mass into a specified percentage when the particles are arranged on an ascending mass basis. For example the D10 is the diameter at which 10% of the sample's mass is comprised of particles with a diameter less than this value. The D50 is the diameter of the particle where 50% of a sample's mass is smaller than and 50% of a sample's mass is larger than this value. The D90 is the diameter at which 90% of the sample's mass is comprised of particles with a diameter less than this value. The D50 value is also called median particle size. From laser diffraction measurements according to ISO 13320 the volumetric D-values are obtained, based on the volume distribution.

The distribution width or span of the particle size distribution is calculated from the D-values D10, D50 and D90 according to equation (3):

$$Span = ( D 90 - D 10 ) / D 50 \qquad equation ( 3 )$$

### c) Density

Density of the polymer was measured according to ISO 1183/1872-2B. For the purpose of this invention the density of the blend can be calculated from the densities of the components according to:

$${ρ}_{b} = {\sum }_{i} {w}_{i} \cdot {ρ}_{i}$$

where
ρ_{b} is the density of the blend,
wᵢ is the weight fraction of component ‘i’ in the blend and
ρᵢ is the density of the component ‘i’.

### d) Differential Scanning Calorimetry (DSC)

Differential scanning calorimetry (DSC) analysis, melting temperature (Tₘ) and melt enthalpy (Hₘ), crystallization temperature (T_{c}), and heat of crystallization (H_{c}, H_{cr}) are measured with a TA Instrument Q200 differential scanning calorimetry (DSC) on 5 to 7 mg samples. DSC is run according to ISO 11357/part 3/method C₂ in a heat/cool/heat cycle with a scan rate of 10° C./min in the temperature range of −30 to +225° C.

Crystallization temperature (T_{c}) and heat of crystallization (H_{c}) are determined from the cooling step, while melting temperature (Tₘ) and melt enthalpy (Hₘ) are determined from the second heating step.

Throughout the patent the term T_{c} or (T_{cr}) is understood as Peak temperature of crystallization as determined by DSC at a cooling rate of 10 K/min (i.e. 0.16 K/sec).

e) Quantification of microstructure by NMR spectroscopy

Quantitative nuclear-magnetic resonance (NMR) spectroscopy was used to quantify the comonomer content of the polymers. Quantitative ¹³C{¹H} NMR spectra recorded in the molten-state using a Bruker Avance III 500 NMR spectrometer operating at 500.13 and 125.76 MHz for 1H and 13C respectively. All spectra were recorded using a ¹³C optimised 7 mm magic-angle spinning (MAS) probe head at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. Standard single-pulse excitation was employed utilising the NOE at short recycle delays and the RS-HEPT decoupling scheme. A total of 1024 (1 k) transients were acquired per spectra using a 3 s recycle delay.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

Basic comonomer content method spectral analysis method:

Characteristic signals corresponding to the incorporation of 1-butene were observed and the comonomer content quantified in the following way.

The amount of 1-butene incorporated in PPBPP isolated sequences was quantified using the integral of the αB2 sites at 43.6 ppm accounting for the number of reporting sites per comonomer:

$$B = {I}_{α} / 2$$

The amount of 1-butene incorporated in PPBBPP double consecutively sequences was quantified using the integral of the ααB2B2 site at 40.5 ppm accounting for the number of reporting sites per comonomer:

$$BB = 2 ⋆ {I}_{αα}$$

When double consecutive incorporation was observed the amount of 1-butene incorporated in PPBPP isolated sequences needed to be compensated due to the overlap of the signals αB2 and αB2B2 at 43.9 ppm:

$$B = ( {I}_{α} - 2 ⋆ {I}_{αα} ) / 2$$

The total 1-butene content was calculated based on the sum of isolated and consecutively incorporated 1-butene:

$${B}_{total} = B + B B$$

The amount of propene was quantified based on the main Sαα methylene sites at 46.7 ppm and compensating for the relative amount of αB2 and αB2B2 methylene unit of propene not accounted for (note B and BB count number of butene monomers per sequence not the number of sequences):

$${P}_{total} = {I}_{S αα} + B + BB / 2$$

The total mole fraction of 1-butene in the polymer was then calculated as:

$${f}_{B} = {B}_{total} / ( {B}_{total} + {P}_{total} )$$

The full integral equation for the mole fraction of 1-butene in the polymer was:

$${f}_{B} = ( ( ( {I}_{α} - 2 ⋆ {I}_{αα} ) / 2 ) + ( 2 ⋆ {I}_{αα} ) ) / ( {I}_{S αα} + ( ( {I}_{α} - 2 ⋆ {I}_{αα} ) / 2 ) + ( ( 2 ⋆ {I}_{αα} ) / 2 ) ) + ( ( {I}_{α} - 2 ⋆ {I}_{αα} ) / 2 ) + ( 2 ⋆ {I}_{αα} ) )$$

This simplifies to:

$${f}_{B} = ( {I}_{α} / 2 + {I}_{αα} ) / ( {I}_{S αα} + {I}_{α} + {I}_{αα} )$$

The total incorporation of 1-butene in mole percent was calculated from the mole fraction in the usual manner:

$$B [ mol - \% ] = 100 ⋆ {f}_{B}$$

The total incorporation of 1-butene in weight percent was calculated from the mole fraction in the standard manner:

$$B [ wt . - \% = 100 ⋆ ( {f}_{B} ⋆ 56. 11 ) / ( ( {f}_{B} ⋆ 56. 11 ) + ( ( 1 - {f}_{B} ) ⋆ 42.08 ) )$$

Details of these procedures can be found in Katja Klimke, Matthew Parkinson, Christian Piel, Walter Kaminsky Hans Wolfgang Spiess, Manfred Wilhelm, Macromol. Chem. Phys. 2006, 207, 382; Matthew Parkinson, Katja Klimke, Hans Wolfgang Spiess, Manfred Wilhelm, Macromol. Chem. Phys. 2007, 208, 2128; Patrice Castignolles, Robert Graf, Matthew Parkinson, Manfred Wilhelm, Marianne Gaborieau, Polymer 2009, 50, 2373; M. Pollard, K. Klimke, R. Graf, H. W. Spiess, M. Wilhelm, O. Sperber, C. Piel, W. Kaminsky, Macromolecules 2004, 37, 813; Xenia Filip, Carmen Tripon, Claudiu Filip, J. Magn. Reson. 2005, 176, 239; John M. Griffin, Carmen Tripon, Ago Samoson, Claudiu Filip, Steven P. Brown, Mag. Res. in Chem. 2007, 45(S1), S198; J. Randall Rev. Macromol. Chem. Phys. 1989, C29, 201.

### f) Xylene Soluble Fraction

The xylene soluble fraction (XCS) is determined according to ISO 16152 at 25° C.

### g) Residual Monomer Content

The residual of butene (C₄) in pellets were detected with static headspace gas chromatography. Agilent 6890 equipped with a flame ionization detector (FID) is used as Gas chromatograph.

Details as follows:
Temperature: 200° C.
Septum purge: 2 ml/min
Total flow: 30 ml/min
Detector Type: FID, Temperature 250° C.
Flows, carrier gas: Helium 3 ml/min
Column Type: 25 m×0.32 mm×2.5 μm
Filling: SE-30
Condition for column: max temperature 250° C.
Sample feeder: Agilent G1888 Headspace sample feeder
Oven: 120° C.
Transferline: 130° C.
Loop: 125° C.
GC cycle time: 40.0 min
Vial EQ time: 60.0 min
Pressurizing time: 0.05 min
Loop fill time: 0.15 min
Loop EQ time: 0.05 min
Inject time: 0.40 min
Carrier helium: 0.81 bar

For each measurement 2000±20 mg samples are used. The information system automatically calculates the analysis of the gas chromatograph with the parameters according to the calculation data if it finds peaks at the correct time intervals. The volatile compounds in the sample (mg/kg) are calculated by the formula:

$$\frac{mg}{kg} = \frac{sum of sample peak areas * Rf}{sample weight ( mg )} * 1 \; 000000$$

$$Rf = factor ( n - octane ) .$$

### Materials

The following catalysts were used in the processes according to the comparative and inventive examples as described in Table 1.

### ZNC1

### Used Chemicals:

20% solution in toluene of butyl ethyl magnesium (Mg(Bu)(Et), BEM), provided by Chemtura
2-ethylhexanol, provided by Amphochem
3-Butoxy-2-propanol-(DOWANOL™ PnB), provided by Dow
bis(2-ethylhexyl)citraconate, provided by SynphaBase
TiCl₄ₛ provided by Millenium Chemicals
Toluene, provided by Aspokem
Viscoplex® 1-254, provided by Evonik
Heptane, provided by Chevron

### Preparation of a Mg Alkoxy Compound

Mg alkoxide solution was prepared by adding, with stirring (70 rpm), into 11 kg of a 20 wt % solution in toluene of butyl ethyl magnesium (Mg(Bu)(Et)), a mixture of 4.7 kg of 2-ethylhexanol and 1.2 kg of butoxypropanol in a 20 l stainless steel reactor. During the addition the reactor contents were maintained below 45° C. After addition was completed, mixing (70 rpm) of the reaction mixture was continued at 60° C. for 30 minutes. After cooling to room temperature 2.3 kg/g of the donor bis(2-ethylhexyl)citraconate was added to the Mg-alkoxide solution keeping temperature below 25° C. Mixing was continued for 15 minutes under stirring (70 rpm).

### Preparation of Solid Catalyst Component

20.3 kg of TiCl₄ and 1.1 kg of toluene were added into a 20 l stainless steel reactor. Under 350 rpm mixing and keeping the temperature at 0° C., 14.5 kg of the Mg alkoxy compound prepared in example 1 was added during 1.5 hours. 1.7 l of Viscoplex® 1-254 and 7.5 kg of heptane were added and after 1 hour mixing at 0° C. the temperature of the formed emulsion was raised to 90° C. within 1 hour. After 30 minutes mixing was stopped catalyst droplets were solidified and the formed catalyst particles were allowed to settle. After settling (1 hour), the supernatant liquid was siphoned away. Then the catalyst particles were washed with 45 kg of toluene at 90° C. for 20 minutes followed by two heptane washes (30 kg, 15 min). During the first heptane wash the temperature was decreased to 50° C. and during the second wash to room temperature.

The thus obtained catalyst ZNC1 was used along with triethyl-aluminium (TEAL) as co-catalyst and dicyclopentyl dimethoxy silane (D-Donor) as donor.

### SSC1

The metallocene complex 1 (rac-anti-dimethylsilandiyl(2-methyl-4-phenyl-5-methoxy-6-tert-butyl-indenyl)(2-methyl-4-(4-tert-butylphenyl)indenyl)zirconium dichloride) has been synthesized as described in WO 2013/007650.

The catalyst was prepared using the metallocene complex 1 and a catalyst system of MAO and trityl tetrakis(pentafluorophenyl)borate according to Catalyst 3 of WO 2015/11135 with the proviso that the surfactant is 2,3,3,3-tetrafluoro-2-(1,1,2,2,3,3,3-heptafluoropropoxy)-1-propanol.

### SSC2

The following metallocene complex 2 has been used as described in WO 2019/179959 A1:

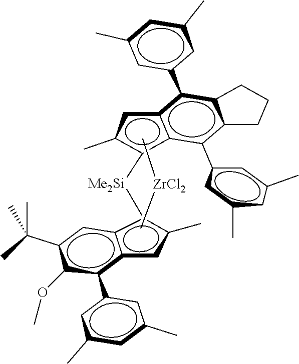

A steel reactor equipped with a mechanical stirrer and a filter net was flushed with nitrogen and the reactor temperature was set to 20° C. Next silica grade DM-L-303 from AGC Si-Tech Co, pre-calcined at 600 C (5.0 kg) was added from a feeding drum followed by careful pressuring and depressurizing with nitrogen using manual valves. Then toluene (22 kg) was added. The mixture was stirred for 15 min. Next 30 wt.-% solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° C. under nitrogen flow for 2 hours and then for 5 hours under vacuum (−0.5 barg) with stirring. MAO treated support was collected as a free-flowing white powder found to contain 12.2% Al by weight.

30 wt.-% MAO in toluene (0.7 kg) was added into a steel nitrogen blanked reactor via a burette at 20° C. Toluene (5.4 kg) was then added under stirring. The metallocene complex MC1 as described above (93 g) was added from a metal cylinder followed by flushing with 1 kg toluene. The mixture was stirred for 60 minutes at 20° C. Trityl tetrakis(pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N2 flow at 60° C. for 2 h and additionally for 5 h under vacuum (−0.5 barg) under stirring.

### EXAMPLES

The following examples were carried out in a Borstar pilot plant, comprising a reactor sequence consisting of a prepolymerisation reactor, a loop reactor and a gas phase reactor (GPR1). Process and properties are given in table 1.

The pelletization of the powder of the base polymers is done in a twin screw extruder with a screw diameter of 18 mm at a melt temperature of 240° C. and a throughput of 7 kg/h.

TABLE 1

| Example | | CE1 | CE2 | CE3 | CE4 | IE1 | IE2 | IE3 |
|---|---|---|---|---|---|---|---|---|
| Catalyst | | ZNC1 | ZNC1 | SSC1 | SSC1 | SSC2 | SSC2 | SSC2 |
| Prepolymerisation reactor | | | | | | | | |
| Temp. | [° C.] | 20 | 20 | 20 | 20 | 20 | 20 | 20 |
| Press. | [kPa] | 5298 | 5105 | 5258 | 4973 | 4919 | 4973 | 5090 |
| Catalyst feed | [g/h] | 1.1 | 1.3 | 0.7 | 0.7 | 5.2 | 3.7 | 3.5 |
| Donor/C3 | [g/t] | 50 | 50 | — | — | — | — | — |
| TEAL/C3 | [g/t] | 160.0 | 160.0 | — | — | — | — | — |
| H2 | [g/h] | 0.98 | 0.98 | 0.10 | 0.10 | 0.12 | 0.12 | 0.12 |
| C3 | [kg/h] | 66.5 | 65.0 | 67.0 | 65.0 | 65.0 | 65.0 | 65.0 |
| Loop reactor | | | | | | | | |
| Temp. | [° C.] | 65 | 60 | 70.0 | 69.9 | 70 | 70 | 65 |
| Press. | [kPa] | 5203 | 5082 | 5138 | 4864 | 4835 | 4840 | 5209 |
| C3 feed | [kg/h] | 147.0 | 131.1 | 174.4 | 174.5 | 187.7 | 189.0 | 179.6 |
| C4 feed | [kg/h] | 25 | 39.5 | 5.9 | 6.5 | 9.8 | 10 | 13.7 |
| C2 feed | [kg/h] | 0.0 | 0.5 | 2.1 | 1.9 | 0.0 | 2.2 | 2.2 |
| Feed H2/C3 ratio | [mol/kmol] | 1.1 | 1.0 | 0.1 | 0.1 | 0.06 | 0.09 | 0.1 |
| Feed C2/C3 ratio | [mol/kmol] | 0 | 6.0 | 17.8 | 16.1 | 0 | 17.06 | 18.5 |
| Feed C4/C3 ratio | [mol/kmol] | 120 | 225 | 30.3 | 25.4 | 39.20 | 39.61 | 57.2 |
| Residence time | [h] | 0.42 | 0.4 | 0.5 | 0.5 | 0.45 | 0.46 | 0.3 |
| Production rate | [kg/h] | 37.0 | 27.9 | 37.6 | 32.5 | 31.4 | 36.6 | 31.6 |
| Solid Concentration | [wt-%] | 24.4 | 31.7 | 33.9 | 30.6 | 21.0 | 23.9 | 13.9 |
| Split | [wt-%] | 58 | 51 | 47 | 41 | 45 | 40 | 61 |
| MFR₂ | [g/10 min] | 5.3 | 5.2 | 56.0 | 59.7 | 4.7 | 3.8 | 3.7 |
| C2 | [wt-%] | 0.0 | 0.4 | 1.0 | 0.9 | 0.0 | 1.0 | 0.6 |
| C4 | [wt-%] | 4.5 | 7.5 | 5.5 | 5.5 | 5.5 | 5.2 | 4.8 |
| XS | % | 3.3 | 5.0 | 1.2 | 1.1 | 0.9 | 1.2 | 1 |
| Gas phase reactor | | | | | | | | |
| Temp. | [° C.] | 80 | 75 | 75 | 75 | 80 | 80 | 80 |
| Press. | [kPa] | 1800 | 1850 | 2480 | 2441 | 2500 | 2524 | 2400 |
| H2/C3 ratio | [mol/kmol] | 13.2 | 25.9 | 1.5 | 1.5 | 1.3 | 2.6 | 1.6 |
| C2/C3 ratio | [mol/kmol] | 0.0 | 10.0 | 121 | 121 | 0 | 109 | 79.1 |
| C4/C3 ratio | [mol/kmol] | 83.7 | 197.5 | 59 | 61 | 43 | 47 | 50.5 |
| C4 feed | [kg/h] | 16.1 | 43.0 | 9.0 | 12.0 | 2.5 | 2.8 | 18.5 |
| Residence time | [h] | 1.4 | 1.3 | 1.7 | 1.7 | 2 | 2 | 2 |
| Split | [wt-%] | 42 | 49 | 53 | 59 | 55 | 60 | 39 |
| MFR₂ | [g/10 min] | 6.3 | 5.5 | 3.6 | 3.0 | 4.9 | 6.0 | 6.7 |
| C2 | [wt-%] | 0 | 1.1 | 1.2 | 1.2 | 0 | 1.2 | 1 |
| C4 | [wt-%] | 5.8 | 8.8 | 5.3 | 6.0 | 4.8 | 6.0 | 6.1 |
| XS | % | 3.1 | 9.0 | 9.4 | 10.0 | 0.6 | 12.0 | 1.6 |
| Total reactor | | | | | | | | |
| Production rate | [kg/h] | 63.3 | 55.0 | 79 | 78 | 74.0 | 92.0 | 52 |
| C4 feed | | 41.1 | 82.5 | 14.9 | 18.5 | 12.3 | 12.8 | 13.6 |
| C4 conversion | % | 9.2 | 5.9 | 27.6 | 34.4 | 28.3 | 43.8 | 23.3 |
| Catalyst productivity | [kg PP/g cat] | 55 | 42 | 118 | 112 | 14 | 25 | 15 |
| Final polymer, powder | | | | | | | | |
| MFR₂ | [g/10 min] | 5.8 | 5.0 | 2.6 | 2.23 | 4.6 | 6.3 | 5.95 |
| C2 | [wt-%] | 0.0 | 1.2 | 1.1 | 1.2 | 0.0 | 1.1 | 1 |
| C4 | [wt-%] | 6.0 | 8.8 | 5.2 | 8.1 | 4.7 | 6.1 | 6.1 |
| XS | % | 3.2 | 8.8 | 17.3 | 14.6 | 0.7 | 12.4 | 1.1 |
| Bulk Density | [kg/m³] | 439 | 438 | 435 | 418 | 497 | 447 | 495 |
| APS | [mm] | 1.23 | 1.17 | 2.2 | 2.1 | 0.9 | 1.3 | 0.82 |
| PSD < 0.106 mm | | 0.25 | 0.02 | 0.0 | 0.0 | 0.0 | 0.0 | 0.07 |
| PSD > 0.106 mm | | 0.42 | 0.2 | 0.1 | 0.5 | 0.1 | 0.1 | 0.14 |
| PSD > 0.250 mm | | 0.15 | 1.9 | 0.2 | 0.5 | 0.5 | 0.2 | 0.32 |
| PSD > 0.355 mm | | 25.53 | 32.92 | 2.9 | 6.0 | 59.6 | 28.1 | 73.55 |
| PSD > 0.850 mm | | 72.21 | 64.72 | 47.8 | 48.6 | 39.4 | 67.7 | 25.79 |
| PSD > 2.0 mm | | 1.44 | 0.24 | 43.0 | 37.3 | 0.5 | 3.7 | 0.13 |
| PSD > 4.0 mm | | 0.00 | 0 | 5.9 | 7.2 | 0.0 | 0.3 | 0 |
| Final polymer, pellet | | | | | | | | |
| MFR₂ | [g/10 min] | 5.6 | 4.9 | 1.94 | 2.03 | 4.4 | 6.7 | 5.6 |
| Tc | [° C.] | 110.7 | 94.5 | 92.5 | 91.2 | 108.6 | 93.2 | 92.3 |
| Tm | [° C.] | 152.8 | 133.0 | 130.8 | 130.2 | 142.8 | 130.2 | 129 |
| Residual C4 | [ppm] | 14 | 7 | 542 | 802 | 6 | 4 | 4 |

From the examples it can be seen that the process using Ziegler Natta catalysts, i.e. comparative examples CE1 and CE2, have very low total comonomer conversions. Therefore, the process of the present invention is more efficient both in terms of energy and material consumption.

Furthermore, it can be seen that non-silica-supported metallocene catalysts known from the prior art as used in comparative examples CE3 and CE4, while achieving similar comonomer conversion rates, exhibit very high residual comonomer in the produced polymer, resulting in high amounts of volatiles in the product. Furthermore, it can also be seen that such catalysts produce powder having particle distributions conferring to higher particle sizes, thereby causing higher C₄ residual content in the product.

Finally, from the inventive examples IE1-IE3 it can be seen that the present invention works well for both type of copolymers, i.e. bipolymers and terpolymers. The C4 conversion is high and the C4 residuals in the product are low.

1. Process for the production of a polypropylene random copolymer (PP), the process comprising the steps of
a) polymerising in a first reactor (R1) propylene and a comonomer (C1a) selected from a C₄ to C₈ α-olefin in the presence of a first metallocene catalyst (MC1) yielding a first polypropylene copolymer (PP1), wherein the ratio of the feed of the comonomer (C1a) to the feed of propylene is in the range of 1 to 100 mol/kmol and the MFR₂ of the first polypropylene copolymer (PP1) is in the range of 0.01 to 100 g/10 min.
b) transferring the first polypropylene copolymer (PP1) to a second reactor (R2),
c) polymerising in the second reactor (R2) and in the presence of said first polypropylene (PP1), propylene, a comonomer (C1b) selected from a C₄ to C₃ α-olefin, and a second metallocene catalyst (MC2) yielding a second polypropylene copolymer (PP2), wherein the ratio of the feed of the comonomer (C1b) to the feed of propylene is in the range of 40 to 150 mol/kmol and the MFR₂ of the second polypropylene copolymer (PP2) is in the range of 0.01 to 100 g/10 min,
d) withdrawing the polypropylene random copolymer (PP) comprising the first polypropylene copolymer (PP1) and the second polypropylene copolymer (PP2) from the second reactor (R2),
wherein the first metallocene catalyst (MC1) and/or the second metallocene catalyst (MC2) is a metallocene catalyst (MC) comprising a metallocene complex,
wherein the metallocene catalyst (MC) comprises a support comprising silica, and
wherein the support has a D50 of between 10 and 80 μm.

2. The process according to claim 1, wherein the first metallocene catalyst (MC1) and/or the second metallocene catalyst (MC2) comprises a complex of formula (I): 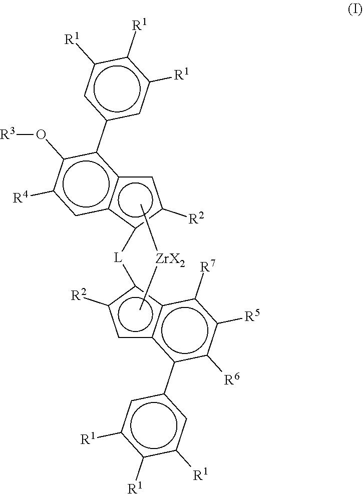
wherein each X independently is a sigma-donor ligand,
L is a divalent bridge selected from —R′₂C—, —R′₂C—CR′₂—, —R′₂Si—, —R′₂Si—SiR′₂—, —R′₂Ge—, wherein
each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,
each R² independently are the same or can be different and are a CH₂—R⁸ group, with R⁸ being H or linear or b ranched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀-aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹,
each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group.

3. The process according to claim 1, wherein the support has an average particle size of from 15 to 80 μm and preferably 18 to 50 μm.

4. The process according to claim 1 wherein the support has an average pore size of from 10 to 100 nm.

5. The process according to claim 1, wherein the comonomer (C1a) and/or the comonomer (C1b) are/is selected from the group consisting of C₄ and C₆ α-olefins, preferably are/is 1-butene.

6. The process according to claim 1, wherein the comonomer (C1a) and the comonomer (C1b) are identical.

7. The process according to claim 6, wherein the polypropylene random copolymer (PP) is a terpolymer and wherein step a) is carried out in the presence of a second comonomer (C2) selected from the group consisting of ethylene and C₄ to C₈ α-olefins, wherein the second comonomer (C2) is different from the comonomer (C1a/C1b), wherein the ratio of the feed of the second comonomer (C2) to the feed of propylene is in the range of 5 to 60 mol/kmol, and step c) is carried out in the presence of the second comonomer (C2), wherein the ratio of the feed of the second comonomer (C2) to the feed of propylene is in the range of 50 to 150 mol/kmol.

8. The process according to claim 7, wherein the second comonomer (C2) is ethylene.

9. The process according to claim 1, wherein step a) is carried out as a slurry-phase polymerisation step and/or the first reactor (RK1) is a loop reactor.

10. The process according to claim 1, wherein in step a) the ratio of the feed of the comonomer (C₁a) to the feed of propylene is in the range of 30 to 50 mol/kmol, preferably 35 to 45 mol/kmol.

11. The process according to claim 3, wherein in step a) the ratio of the feed of the second comonomer (C2) to the feed of propylene is in the range of 10 to 20 mol/kmol, preferably 13 to 18 mol/kmol.

12. The process according to claim 1, wherein step c) is carried out as a gas-phase polymerisation step and/or the second reactor (RK2) is a gas-phase reactor, preferably step c) is carried out as a fluidized bed gas-phase polymerisation step and/or the second rector (2) is fluidized bed gas-phase reactor.

13. The process according to claim 1, wherein in step c) the ratio of the feed of the comonomer (C1b) to the feed of propylene is in the range of 40 to 60 mol/kmol, preferably 45 to 50 mol/kmol.

14. The process according to claim 7, wherein in step c) the ratio of the feed of the second comonomer (C2) to the feed of propylene is in the range of 90 to 130 mol/kmol, preferably 105 to 115 mol/kmol.

15. The process according to claim 1, wherein the polypropylene random copolymer (PP) has a combined residual content of the comonomer (C1a) and the comonomer (C1b) of lower than 6.5 ppm, preferably lower than 5 ppm, and most preferably lower than 4 ppm.
